(19) United States
(12) Patent Application Publication
(10) Pub. No.: US 2022/0346354 A1
(43) Pub. Date: Nov. 3, 2022

(54) WIRELESS BEHAVIOR CONTROL DEVICE

(71) Applicant: Adam Marco MAGANZINI, Malden, MA (US)

(72) Inventor: Adam Marco MAGANZINI, Malden, MA (US)

(21) Appl. No.: 17/735,670

(22) Filed: May 3, 2022

Related U.S. Application Data
(60) Provisional application No. 63/183,193, filed on May 3, 2021.

(51) Int. Cl. A01K 27/00; G08B 21/18; G08B 25/10; H04W 4/029; H04W 4/38

(52) U.S. Cl. CPC A01K 27/009; G08B 21/182; G08B 25/10; H04W 4/029; H04W 4/38

(57) ABSTRACT

An “invisible” leash that wirelessly connects a pet device to a user device and provides signals to a pet device for controlling pet behavior is disclosed. The pet device can include one or more sensors and output devices to communicate instructions and control pet behavior.

### RELATED APPLICATION

This patent application claims the benefit of priority to the U.S. Provisional Patent Application No. 63/183,193, filed May 3, 2021, and titled “WIRELESS BEHAVIOR CONTROL DEVICE” which is incorporated herein by reference in its entirety.

### TECHNICAL FIELD

The present disclosure relates to computerized systems and methods for controlling human or pet behavior, and in particular, to a wireless bracelet, collar, or leash.

### BACKGROUND

Traditionally, pets have been controlled using leashes. Leashes have been used to keep dogs close to their owners on walks, jogs, or in other situations out in public. Dog owners have been able to control their dogs by lengthening or tightening the leash. Physical leashes can be problematic, however, as both dog owners and dogs can become tangled in the leash. This problem is compounded when one dog walker is responsible for walking multiple dogs.

### BRIEF DESCRIPTION OF FIGURES

Various objectives, features, and advantages of the disclosed subject matter can be more fully appreciated with reference to the following detailed description of the disclosed subject matter when considered in connection with the following drawings, in which like reference numerals identify like elements.

FIG. 1 is a system diagram showing a networked system for implementing a wireless pet control mechanism, according to some embodiments of the present disclosure.

FIG. 2 is a diagram showing a user device, according to some embodiments of the present disclosure.

FIG. 3 is a diagram showing a pet device, according to some embodiments of the present disclosure.

FIG. 4 is a screenshot of a user application, according to some embodiments of the present disclosure.

FIG. 5 is a computerized method for implementing a wireless pet control mechanism, according to some embodiments of the present disclosure.

### DETAILED DESCRIPTION

Systems and methods are described herein for an “invisible” leash that wirelessly connects a pet device to a user device (e.g., via Bluetooth) and provides signals to a pet device for controlling pet behavior. For example, the pet device can control how far a pet (e.g., dog, cat) can stray away from a user device without either receiving a small zap or hearing a programmed sound (for example, a beeping sound that gets louder or faster as the dog goes out of the set proximity range).

In some embodiments, a user (e.g., a dog walker) can connect to and control multiple pet devices at once. The pet device can include one or more sensors and can, for example, provide a location by GPS or monitor the pet's vital information. The pet device can also include one or more output devices, such as a speaker, such that a user can speak into an input device of the user device, such as a microphone, and have commands or instructions communicated to the pet via the pet device speaker.

In some embodiments, the “invisible” leash techniques described herein can also be used to control human behavior. For example, the device described herein can be implemented as a computing device attached to a bracelet worn by a person. The computing device can control the proximity of an individual to objects (e.g., valuable or fragile items) and to other people (e.g., in the context of restraining orders). The computing device can also be attached to objects to detect and control proximity of one object to another.

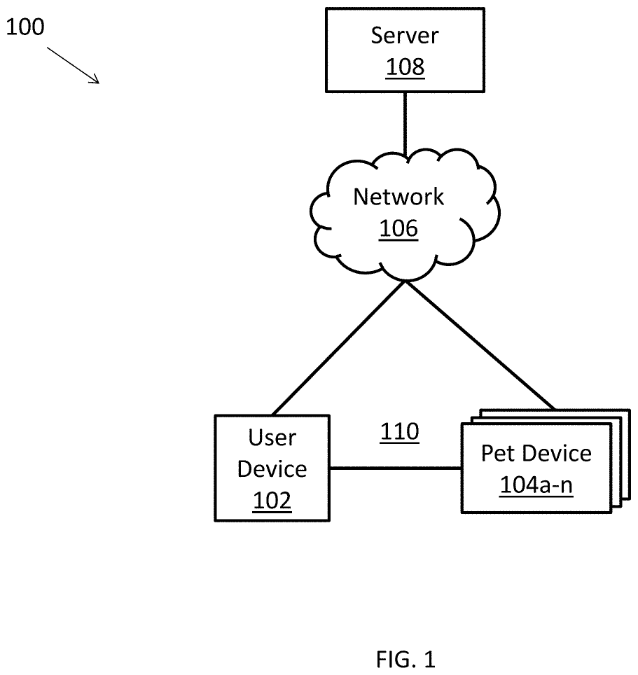

FIG. 1 is a system diagram showing a networked system for implementing an invisible leash, according to some embodiments of the present disclosure. System 100 includes user device 102, pet device(s) 104a-n (also referred to herein as 104), network 106, server 108, connection 110 between user device 102 and pet device 104.

User device 102 communicates with server 108 over network 106. User device 102 also communicates with one or more pet devices 104 over communication channel 110. User device 102 can be any device capable of communicating over network 106 and communication channel 110. For example, user device 102 can be a laptop, personal computer, cell phone, including a personal digital assistant (PDA), a smartphone, or a smart watch.

Pet device 104a-n communicates with server 108 over network 106. Each of pet device 104a-n also communicates with user device 102 over communication channel 110. Pet device 104a-n can be any device capable of communicating over network 106 and communication channel 110. In some embodiments, pet device 104 is a computing device that attaches to a collar or harness worn by the pet. As described below, pet device 104 can also be worn by people. Pet device 104 can be secured using a snap on feature that attaches to a collar, an accessory, or an article of clothing. Pet device 104 can also be secured to objects via magnets or other fasteners.

Server 108 communicates with both user device 102 and pet device 104a-n over network 106. Network 106 can be any type of network, including a local area network, or a wide area network such as the Internet. Connection 110 can also include any type of network or connection. In some embodiments, connection 110 is a short distance wireless network or personal area network, such as Bluetooth or wireless USB.

An example of how the system shown in FIG. 1 is used will be described in the context of dog walking. In this example, user device 102 is a smart phone carried by a dog walker. Pet device 104a-n is a computing device attached to a dog's collar. Pet device 104a-n can be multiple computing devices, each device attached to a different dog collar. For example, some dog walkers walk more than one dog. User device 102 can send instructions to each of the pet devices 104 to keep the dog(s) within a certain distance of user device 102. The distance from user device 102 is configurable by the dog walker or can be preprogrammed (e.g., downloaded from server 108) or based on information about the type of dog received from pet device 104. Examples of distances for dog walking range from 3 feet to 10 feet, 20 feet, or 30 feet. The distance is configurable based on the setting, number of dogs, or other environmental factors.

Using location or distance tracking, user device 102 can track the location of pet devices 104 and output an alert when the distance exceeds a threshold. Location tracking can be accomplished using any combination of GPS, Bluetooth, WiFi, or other location tracking techniques. Pet device 104 can also output a signal based on the distance exceeding a threshold. For example, pet device 104 can emit a sound or haptic feedback that encourages the dog not to proceed any further from user device 102. Examples of sounds unpleasant to dogs and that encourage them to return to the user device include an inaudible whistle, metal whining and screeching, a siren, an alarm, telephone ringing, sawing wood, or beeping. A sound can also include communication from user device 102 (e.g., someone issuing commands from device 102). Examples of haptic feedback include vibrating mechanisms and buzzers that may be embedded within pet device 102 that is further attached to the pet collar. Once activated, the haptic device would stimulate the dog to follow in a certain direction. A dog can also be “railed back in” towards user device 102 using other wireless techniques, for example, adjusting a magnetic force between user device 102 and pet device 104. A dog can also be railed back in by way of sounds being played from other pet devices where the owner desires the pet to go. For example, the dog can be trained to go to a desired location, such as its feeding spot, by hearing the sounds from another pet device that is placed at the location. Pet device 104 can also monitor a dog's vital signs and provide indication of a dog's condition to user device 102.

In some embodiments, pet device 104 can be worn by people to maintain distance between people (e.g., to enforce a restraining order), to keep people within a certain area (e.g., hospital patients, children), and to keep people from bumping into valuable or fragile objects. The feedback control includes similar audio and haptic controls as mentioned above, but would be adapted to affect human behavior instead of pet behavior.

In some embodiments, pet device 104 includes a video camera to monitor the surroundings of the pet. For example, user device 102 can view and record the surroundings of the pet device in real time to ensure the pet is in a safe surrounding. If the user determines that the pet is in an unsafe location, the user can send an alert signal to the pet device, encouraging the dog to return to the user device or a safe location.

In some embodiments, pet device 104 includes a video camera for surveillance purposes. For example, pet device 104 can be used to observe certain areas of a house, such as the entrance or exit doors. Pet device 104 can be mounted to a location near the area to be surveilled, such as the walls, celling, exterior facade, lamp posts, etc. In certain embodiments, the pet device can include motion sensors that detect movement in a specified area. Once a movement is detected, the pet device can alert user device 102 via the communication network 106 or communication channel 110.

In some embodiments, pet device 104 can include a proximity sensor that prevents the pet from approaching too close to a person or another pet/animal. User device 102 can set the distance range of the proximity sensor of the pet device via communication network 106 or communication channel 110, depending on what the user believes is a safe distance to be maintained from the pet wearing the pet device. Once the proximity sensor detects the presence of an object (a person or animal), an alert signal is activated on the pet device, encouraging the pet to move away from the object.

In some embodiments, each pet device 104 includes a proximity sensor that prevents the pets from approaching too close to each other. User device 102 can set the distance range of the proximity sensor of the pet device via communication network 106 or communication channel 110, depending on what the user believes is a safe distance to be maintained between the pets wearing the pet devices. Once the proximity sensor on a first pet device detects the presence of a second pet device, an alert signal is activated on the first pet device, encouraging the pet to move away from the second pet device. This is helpful where it is desired not to have more than one pet in a given location, for example, the feeding spot, where the pets may become aggressive with each other. If one pet wearing the pet device is already feeding at the feeding spot, the proximity sensors on pet devices worn by other pets will alert and deter them from approaching the feeding location. Alternatively, if it is desired to stop the pets from entering the feeding spot for some reason, a pet device may be placed at the feeding spot. Once a pet breaches the set safe distance to the pet device located at the feeding spot, the proximity sensor on its pet device will set off an alert which will deter the pet away from the feeding spot.

In some embodiments, user device 102 is an unmanned aerial vehicle (UAV), i.e., a drone. The drone user device can supervise the pet walking activity by flying over pet device 104 to control pet's movement and behavior. Such system and method may eliminate the need for a human as a pet walker. The drone user device can include a GPS navigation system to track the location of pet device 104. The drone user device can guide pet device 104 to follow a certain direction or path by outputting an alert. For example, the drone user device can shine light, play sounds or whistle to keep the pets focused on it when on their walks or to draw a pet's attention towards a desired direction when the drone user device determines that the pet has strayed in a wrong direction.

In some embodiments, the drone user device can employ in-built video camera(s) to determine a pet's location and send alerts to pet device 104 when the distance exceeds a threshold. For example, the in-built camera, along with speaker(s) and thermal sensor(s) can record the location, any activities desired, etc., of the pet that can be accessed by the user. In addition, an omnidirectional (360-degree) camera could be used to allow for enhanced awareness of the surroundings.

In some embodiments, the drone user device can employ laser- or radar-based methods to detect the location and determine the distance of a pet device 104 from the drone user device. The distance of pet device 104 may be determined following light reflection principle used by the laser-based distance measurement techniques such as laser distance meters and light detection and ranging (LIDAR) method.

In some embodiments, the drone user device may include a projector that displays information to guide or alert a person wearing pet device 104. The projector may display directions, local maps and real-time traffic obstructions, on the ground and in vicinity of the person or in mid-air to enhance the person's awareness of the surroundings and overall safety. For example, outdoor adventurers, including mountaineers, wildlife explorers, hikers, hunters, sailors, etc., wearing the leash system can be alerted with projections regarding the presence of obstructions, predators and other potential threats in their path to improve their safety and overall experience.

In some embodiments, user device 102 is a car with wheels. The car user device can supervise the pet walking activity by driving in the vicinity of pet device 104 to control pet's movement and behavior. Such system and method may eliminate the need for a human as a pet walker. The car user device can include a GPS navigation system to track the location of pet device 104. The car user device can guide pet device 104 to follow a certain direction or path by outputting an alert. For example, the car user device can shine light, play sounds or whistle to keep the pets focused on it when on their walks or to draw a pet's attention towards a desired direction when the car user device determines that the pet has strayed in a wrong direction.

In some embodiments, the car user device can employ in-built video camera(s) to determine a pet's location and send alerts to pet device 104 when the distance exceeds a threshold. For example, the in-built camera, along with speaker(s) and thermal sensor(s) will record the location, any activities desired, etc., of the pet that can be accessed by the user. In addition, an omnidirectional (360-degree) camera could be used to allow for enhanced awareness of the surroundings.

In some embodiments, the car user device can employ laser- or radar-based methods to detect the location and determine the distance of a pet device 104 from the car user device. The distance of pet device 104 may be determined following light reflection principle used by the laser-based distance measurement techniques such as laser distance meters and LIDAR.

In some embodiments, the car user device may include a projector that displays information to guide or alert a person wearing pet device 104. The projector may display directions, local maps and real-time traffic obstructions, on the ground and in vicinity of the person or in mid-air to enhance the person's awareness of the surroundings and overall safety. For example, outdoor adventurers, including mountaineers, wildlife explorers, hikers, hunters, sailors, etc., wearing the leash system can be alerted with projections regarding the presence of obstructions, predators and other potential threats in their path to improve their safety and overall experience.

In some embodiments, pet device 104 includes a projector to guide or alert a person wearing the pet device. In addition, the projector may be used for entertainment purposes and to project computer, phone or television screen for the person wearing the pet device.

In some embodiments, pet device 104 includes thermal sensors, such as the infrared and laser-based temperature sensors, to detect the presence of animals such as the rodents. Once pet device 104 detects presence of an animal, it will send an alert to user device 102. Further, user device 102 may be a drone or a car that can chase away the animals.

In some embodiments, the exterior of pet device 104 is composed of high-strength and durable materials, including metals, steel, alloys, polycarbonate, high density polyethylene, high-strength composites, or combinations thereof.

In some embodiments, pet device 104 can be secured inside a high-strength and durable protective case that is attached to the collar. The protective case may be composed of metals, steel, alloys, polycarbonate, high density polyethylene, high-strength composites, or combinations thereof

In some embodiments, pet device 104 can be attached to wild animals, such as lions, bears, etc., to monitor and control their movements. For example, a drone user device may be flown over a wild animal wearing pet device 104 to track its movement and direct the animal away if it reaches in proximity of humans or cattle.

The size of pet device 104 may depend upon the size and breed of the pet. In some embodiments, smaller size pet device may include basic features such as GPS, location tracking, sound alarm, while larger size pet device may include additional features such as camera, variety of other alarms, etc. The larger size pet device may also include LED lights that can change to any desired color within the color spectrum and will be able to be synchronized with each device to work together. For example, if desired, if one has five pet devices, each one can display a different or same colored light as the other ones, such that together these colored lights will indicate or warn of the presence of cats or dogs or humans or fragile objects, etc.

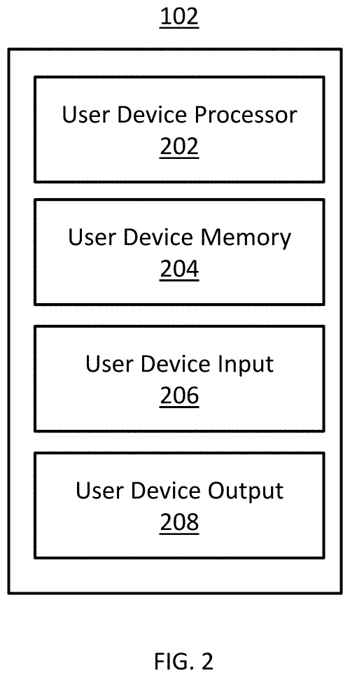

FIG. 2 is a diagram showing a user device 102, according to some embodiments of the present disclosure. User device 102 includes user device processor 202, user device memory 204, user device input 206, and user device output 208.

User device processor 202 performs operations and processes for user device 102, including the operations and processes described herein. User device processor 202 can execute software and instructions stored in user device memory 204. Also stored in user device memory 204 is data associated with the wireless pet control processes described herein. For example, user device memory 204 can store information related to pet devices and pet device settings the user device communicated with previously. Types of information stored can include pet device IDs, vital signs previously measured by pet device 104, or distances previously set or measured by pet device 104.

User device input 206 includes circuitry and or software for receiving inputs at user device 102. User device input 206 can include a user interface, one or more sensors, or an input port for receiving input data. Types of input data include information received via a user interface or from a sensor on the user device 102, downloaded from server 108, or received from pet device 104. Inputs from a user interface can include an activity type (walking, running, sitting), type or breed of pet (e.g., dog or cat; Labrador, husky, or dachshund), location of activity, size of a pet, age of a pet, and vital information for a pet. Information downloaded from a server 108 can include typical characteristics of pets or information previously saved by a user online. For example, a user can download profiles for different pets and pet devices 104. User device sensors can include a haptic sensor for detecting motion from user device 102, aural sensor for detecting vocal commands or other sound, and visual sensor for detecting environmental conditions (e.g., density of crowds, obstacles). User device sensors can also include a GPS sensor for detecting a location of user device 102. User device inputs can be considered in determining a maximum proximity distance between user device 102 and pet device 104. The proximity distance can also be manually input via the user interface and received via user device input 206.

User device output 208 includes circuitry and or software for providing outputs at user device 102. User device outputs are provided based on the inputs received at the user device input 206. For example, a user device output can include displaying pet device metrics at a display on user device 102. As described in more detail below, user device outputs can also cause one or more actions at pet device 104 (e.g., causing pet device 104 to provide a haptic signal, an aural signal, or a visual signal).

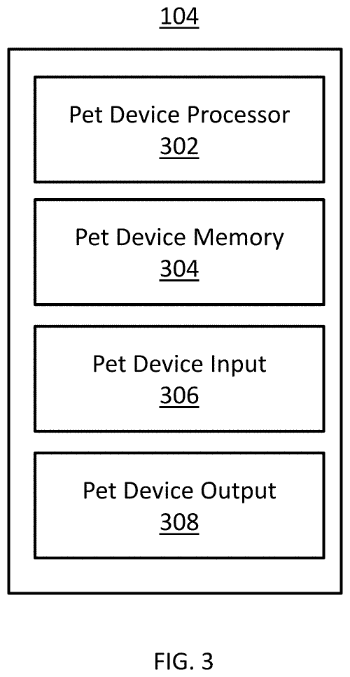

FIG. 3 is a diagram showing a pet device 104, according to some embodiments of the present disclosure. Pet device 104 includes pet device processor 302, pet device memory 304, pet device input 306, and pet device output 308.

Pet device processor 302 performs operations and processes for the pet device 104, including the operations and processes described herein. Pet device processor 302 can execute software and instructions stored in pet device memory 304. Also stored in pet device memory 304 is data associated with the wireless pet control processes described herein. For example, pet device memory 304 can store information related to pet devices and pet device settings. Types of information stored can be intensity of haptic and aural settings based on prior measured pet device data.

Pet device input 306 includes circuitry and or software for receiving inputs at pet device 104. Pet device input 306 can include one or more sensors or an input port for receiving input data (e.g., from user device 102 or server 108). Information downloaded from a server 108 can include pet characteristics previously saved online by a user. For example, a pet's profile can be advantageously loaded from a server onto pet device 104 when different pets share the same pet device 104. Profile information can include type or breed of pet (e.g., dog or cat; Labrador, husky, or dachshund), size of a pet, age of a pet, and historical vital information for the pet. Pet device sensors can include a haptic sensor for detecting motion from pet device 104, aural sensor for detecting breathing or other pet sounds, and visual sensor for detecting environmental conditions (e.g., density of crowds, obstacles). Pet device sensors can also include a GPS sensor for detecting a location of pet device 104. Pet device inputs can be considered in determining a maximum proximity distance between user device 102 and pet device 104. Pet device inputs can also be considered in determining a type and intensity of haptic or aural feedback.

Pet device output 308 includes circuitry and or software for providing outputs at pet device 104. Pet device outputs are provided based on the inputs received at pet device input 306. For example, a pet device output can include haptic feedback (e.g., a shock from pet device 104, tightening of a collar) or aural feedback (e.g., metal whining and screeching, a siren, an alarm, telephone ringing, sawing wood, or beeping). Pet device output can also include a visual projection (e.g., a light directing the pet to move closer to user device 102) or a varying magnetic field drawing pet device 104 closer to user device 102. In some embodiments, the purpose of the aural, haptic, and visual feedback is to prevent the pet from straying beyond a maximum proximity threshold from user device 102.

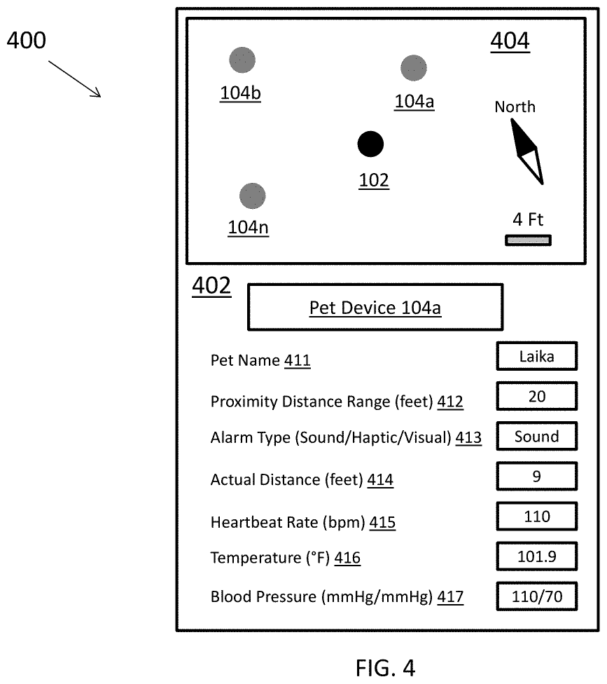

FIG. 4 is a screenshot of a user interface (UI) application 400 residing in the user device 102, according to some embodiments of the present disclosure. UI 400 can display control settings 402 and a GPS map 404 of the pet device(s) 104. Control settings 402 includes profile information of the pet wearing the pet device 104 and allows the user to adjust the settings of pet device 104. For example, control settings 402 can display pet name 411, actual distance 414 between pet device 104 and user device 102, heartbeat rate 415 of the pet, temperature 416 of the pet, and blood pressure 417 of the pet. In addition, control settings 402 can control how multiple pet devices 104 interact with each other and with user device 102. A user can set the proximity distance range 412 and alarm type 413 (such as sound, haptic, and visual) that is set off when the pet goes out of the range. GPS map 404 displays the locations of user device 102 and pet device(s) 104a-n. For a better visual representation of the GPS map, user device 102 is preferably shown in the center of the map. To distinguish user device 102 from pet devices 104a-n in UI 400, user device 102 is shown in a different color than that of the pet devices. GPS map 404 also includes navigation features, such as a compass icon for locating direction and a scale bar for distance guidance, that help user of user device 102 to have an enhanced awareness of the locations of the pets. UI 400 application can allow a user to establish network communication between the user device and the pet device. In addition, UI 400 can allow a user to create and modify profile information of the pets, including the name, breed, age, size of the pets.

In some embodiments, the user device can receive the vital signs of the pet wearing the pet device, such as the heart rate, temperature, breathing rate, and the blood pressure, and subsequently displays them on the UI application on the device. Furthermore, in certain embodiments, the UI can display an alert message in case the vital signs are not within a preset range. For example, if the breathing rate of the pet is higher than a preset acceptable value, the UI can display a message to indicate that the pet needs water, food, or medication.

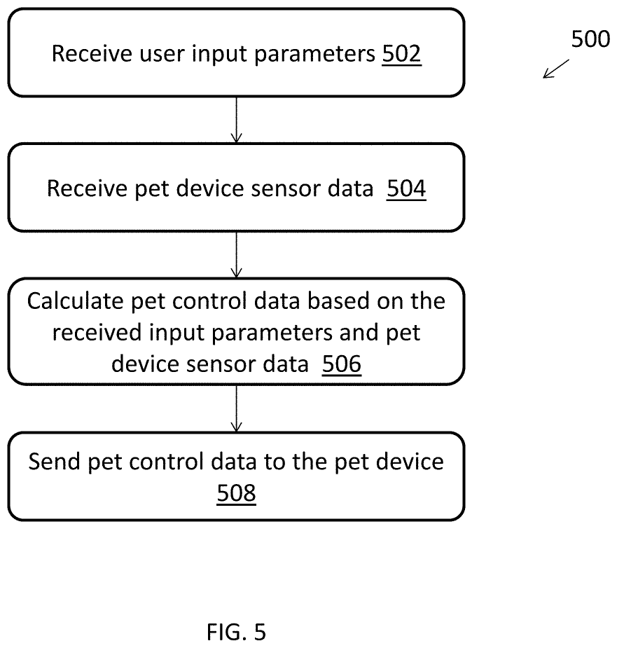

FIG. 5 is a computerized method for implementing a wireless pet control mechanism, according to some embodiments of the present disclosure.

Referring to step 502, software running on a user device 102 receives user input parameters. As described above in the text accompanying FIG. 2, user input parameters can include an activity type (walking, running, sitting), type or breed of pet (e.g., dog or cat; Labrador, husky, or dachshund), location of activity, size of a pet, age of a pet, and vital information for a pet. Information downloaded from a server 108 can include typical characteristics of pets or information previously saved by a user at server 108.

Referring to step 504, software running on a user device 102 receives pet device sensor data. As described above in the text accompanying FIG. 3, pet device sensors can include a haptic sensor for detecting motion from pet device 104, aural sensor for detecting breathing or other pet sounds, and visual sensor for detecting environmental conditions (e.g., density of crowds, obstacles). Pet device sensors can also include a GPS sensor for detecting a location of pet device 104.

Referring to step 506, software running on a user device 102 calculates pet control data based on the received input parameters and pet device sensor data. As described above in the text accompanying FIGS. 2 and 3, a maximum proximity distance can be calculated based on input parameters received at user device 102, from server 108, and pet device 104. For example, based on a user input of dog walking as an activity type at user device 102, a pet profile downloaded from server 108 indicating pet device 104 is attached to a Labrador puppy, and vital sign information from pet device 104 indicating that the puppy is still weak from a cold, a maximum proximity distance is calculated for pet device 104. Also calculated can be suggested feedback for keeping the puppy within the maximum proximity distance. For example, based on currently sensed data (e.g., how often the puppy is pushing against the proximity distance) and profile information (e.g., feedback information that worked previously for the puppy), the feedback data applied to the puppy is also adjusted based on input data.

Referring to step 508, software running on a user device 102 sends pet control data to the pet device. As described above in the text accompanying FIGS. 2 and 3, pet control data can include haptic, aural, or visual feedback that keeps the pet within a maximum proximity distance from user device 102.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of nonvolatile memory, including by way of example semiconductor memory devices, (e.g., EPROM, EEPROM, and flash memory devices); magnetic disks, (e.g., internal hard disks or removable disks); magneto optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back end component (e.g., a data server), a middleware component (e.g., an application server), or a front end component (e.g., a client computer having a graphical user interface or a web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

1. A system for pet control, the system comprising:
at least one pet device including at least one sensor configured to detect sensor data related to a pet; and
a user device including at least one processor and at least one memory, the at least one memory storing instructions that, when executed by the at least one processor, cause the at least one processor to perform operations comprising:
receiving at least one user input from a user;
receiving the sensor data from the at least one pet device over a wireless network; and
calculating pet control data based on the at least one user input and the sensor data.

2. The system according to claim 1, wherein the at least one user input includes a maximum proximity distance, the sensor data includes a distance amount indicating a distance between the at least one pet device and the user device, and the calculating pet control data includes determining if the distance amount is larger than the maximum proximity distance.

3. The system according to claim 1, wherein the at least one user input includes a distance threshold, the sensor data includes a distance amount indicating a distance between the pet and another pet, and the calculating pet control data includes determining if the distance amount is smaller than the distance threshold.

4. The system according to claim 1, wherein the operations performed by the at least one processor further comprises sending the pet control data to the at least one pet device over the wireless network, the pet control data being configured to instruct the at least one pet device to provide alarm to the pet.

5. The system according to claim 4, wherein:
the at least one pet device includes a collar worn by the pet; and
the pet control data is further configured to instruct the collar to tighten.

6. The system according to claim 4, wherein the alarm includes haptic feedback, aural feedback, or visual feedback. The system according to claim 4, wherein the calculating pet control data includes determining a type or an intensity of the alarm based on the sensor data.

8. The system according to claim 7, wherein the type or the intensity of the alarm is adjustable based on the at least one user input.

9. The system according to claim 1, wherein the at least one user input includes profile data of the pet or an activity type, the sensor data includes pet device location data, the at least one sensor includes a location sensor configured to detect the pet device location data, the calculating pet control data further comprises:
calculating a maximum proximity distance based on the at least one user input;
calculating a distance between the at least one pet device and the user device based on the pet device location data; and
determining if the distance is larger than the maximum proximity distance.

10. The system according to claim 9, wherein the calculating pet control data further comprises generating pet control data configured to instruct the pet device to provide alarm to the pet if the distance is determined to be larger than the maximum proximity distance.

11. The system according to claim 1, wherein the at least one sensor includes a thermal sensor configured to detect the presence of animals surrounding the pet.

12. The system according to claim 1, wherein the sensor data includes vital signs of the pet, the operations performed by the at least one processor further comprises determining if the vital signs of the pet is out of a preset range, and the user device is configured to display an alert message if the vital signs of the pet are determined to be out of the preset range.

13. The system according to claim 1, wherein the user device is a drone configured to follow the pet.

14. The system according to claim 1, wherein the user device is a car configured to walk the pet independent of a human walker.

15. A method for pet control using a user device, the method comprising:
receiving at least one user input from a user;
receiving sensor data related to a pet from at least one pet device over a wireless network, the at least one pet device including at least one sensor configured to detect the sensor data;
calculating pet control data based on the at least one user input and the sensor data; and
sending pet control data to the at least one pet device over the wireless network.

16. The method according to claim 15, wherein the step of receiving the at least one user input includes receiving a maximum proximity distance from the user, wherein the step of receiving the sensor data includes receiving a distance amount indicating a distance between the at least one pet device and the user device, and wherein the step of calculating the pet control data includes determining if the distance amount is larger than the maximum proximity distance.

17. The method according to claim 16, wherein the step of sending the pet control data to the at least one pet device includes instructing the at least one pet device by the pet control data to prevent the pet from straying beyond the maximum proximity threshold from the user device.

18. The method according to claim 16, wherein the step of sending the pet control data to the at least one pet device includes instructing the at least one pet device by the pet control data to provide a visual projection directing the pet to move closer to the user device.

19. The method according to claim 15, wherein the step of sending the pet control data to the at least one pet device includes instructing the at least one pet device by the pet control data to provide alarm to the pet, the alarm including haptic feedback, aural feedback, or visual feedback.

20. The method according to claim 15, wherein the step of receiving the sensor data includes receiving per device location data, and wherein the step of calculating the pet control data includes:
calculating a maximum proximity distance based on the at least one user input, the at least one user input including profile data of the pet or an activity type;
calculating a distance between the at least one pet device and the user device based on the pet device location data; and
determining if the distance is larger than the maximum proximity distance.
